(19) United States
(12) Patent Application Publication
(10) Pub. No.: US 2021/0261153 A1
(43) Pub. Date: Aug. 26, 2021

(54) INFORMATION PROCESSING APPARATUS, INFORMATION PROCESSING METHOD, STORAGE MEDIUM, AND VEHICLE

(71) Applicant: TOYOTA JIDOSHA KABUSHIKI KAISHA, Toyota-shi (JP)

(72) Inventors: Yuki NAKANO, Nisshin-shi (JP); Masato URA, Nisshin-shi (JP); Koji TAKAO, Toyota-shi (JP); Hideyuki SAKURAI, Toyota-shi (JP); Keisuke HOTTA, Miyoshi-shi (JP); Rieko MASUTANI, Toyota-shi (JP); Atsushi HANAWA, Miyoshi-shi (JP); Masanobu OHMI, Kasugai-shi (JP); Takashi HAYASHI, Nagoya-shi (JP); Atsushi NABATA, Nagakute-shi (JP); Tetsuro SAKAGUCHI, Toyota-shi (JP)

(73) Assignee: TOYOTA JIDOSHA KABUSHIKI KAISHA, Toyota-shi (JP)

(21) Appl. No.: 17/177,535

(22) Filed: Feb. 17, 2021

(30) Foreign Application Priority Data
Feb. 25, 2020 (JP) 2020-029732

(51) Int. Cl. B60W 60/00; G01C 21/34; G01C 21/36; G06K 9/00

(52) U.S. Cl. CPC B60W 60/001; G06K 9/00838; G01C 21/3605; G01C 21/3438

(57) ABSTRACT

An information processing apparatus which controls a plurality of vehicle platforms which can be coupled to and separated from a predetermined vehicle interior unit, the information processing apparatus comprises a controller configured to execute: transmitting a first command to transport the vehicle interior unit to a first location and install the vehicle interior unit, to one of the plurality of vehicle platforms; and in a case where all people who are to be on board the vehicle interior unit and move are on board the installed vehicle interior unit, transmitting a second command to transport the vehicle interior unit to a second location which is a destination of the people, to one of the plurality of vehicle platforms.

### CROSS REFERENCE TO THE RELATED APPLICATION

This application claims the benefit of Japanese Patent Application No. 2020-029732, filed on Feb. 25, 2020, which is hereby incorporated by reference herein in its entirety.

### BACKGROUND

### Technical Field

The present disclosure relates to a technique of providing mobile service by a vehicle.

### Description of the Related Art

Attempts to provide service by dispatching an autonomous driving car which is designed for various applications have been made. For example, Patent document 1 discloses an apparatus which determines a vehicle to be dispatched on the basis of a demand for service and an operating status of a vehicle and instructs the vehicle to move.

Further, there is an idea of utilizing an autonomous driving car as a meeting place. By setting a vehicle itself as a meeting place, it is possible to provide space appropriate for meeting at any location. Further, it is possible to immediately depart at a timing at which a plurality of people gather together.

### CITATION LIST

[Patent document 1] Japanese Patent Laid-Open No. 2019-075047
[Patent document 2] Japanese Patent Laid-Open No. 2007-072588

### SUMMARY

In a case where a vehicle is set as a meeting place, the vehicle remains parked until all people who are to meet get together. That is, there occurs a time period during which a vehicle is not utilized as a mobile body.

The present disclosure has been made in view of the above-described problem and is directed to reducing an idle time of a vehicle to be used for meeting.

The present disclosure in its one aspect provides an information processing apparatus which controls a plurality of vehicle platforms which can be coupled to and separated from a predetermined vehicle interior unit, the information processing apparatus comprising: a controller configured to execute: transmitting a first command to transport the vehicle interior unit to a first location and install the vehicle interior unit, to one of the plurality of vehicle platforms; and in a case where all people who are to be on board the vehicle interior unit and move are on board the installed vehicle interior unit, transmitting a second command to transport the vehicle interior unit to a second location which is a destination of the people, to one of the plurality of vehicle platforms.

The present disclosure in its another aspect provides an information processing method for controlling a plurality of vehicle platforms which can be coupled to and separated from a predetermined vehicle interior unit, the information processing method comprising: a step of transmitting a first command to transport the vehicle interior unit to a first location and install the vehicle interior unit, to one of the plurality of vehicle platforms; and a step of, in a case where all people who are to be on board the vehicle interior unit and move are on board the installed vehicle interior unit, transmitting a second command to transport the vehicle interior unit to a second location which is a destination of the people, to one of the plurality of vehicle platforms.

The present disclosure in its another aspect provides a vehicle comprising: a controller configured to execute: performing first operation of transporting a predetermined vehicle interior unit to a first location and installing the vehicle interior unit; and in a case where all people who are to be on board the vehicle interior unit and move are on board the installed vehicle interior unit, performing second operation of transporting the vehicle interior unit to a second location which is a destination of the people.

Further, as another aspect, a program for causing a computer to execute the information processing method to be executed by the above-described information processing apparatus or a computer-readable storage medium which non-temporarily stores the program is provided.

According to the present disclosure, it is possible to reduce an idle time of a vehicle to be used for meeting.

### BRIEF DESCRIPTION OF THE DRAWINGS

FIG. 1 is an overall configuration diagram of a vehicle system according to a first embodiment.

FIG. 2 is an appearance view of a chassis unit and a vehicle interior unit.

FIG. 3 is a view illustrating a system configuration of a server apparatus.

FIGS. 4A and 4B illustrate examples of chassis data and vehicle interior data.

FIG. 5 is a view illustrating system configurations of the vehicle interior unit and the chassis unit.

FIG. 6 is a flowchart of processing to be performed by the server apparatus.

FIG. 7 is a flowchart of processing to be performed by the chassis unit.

FIG. 8 is a flowchart of processing to be performed by the vehicle interior unit.

### DESCRIPTION OF THE EMBODIMENTS

An information processing apparatus according to the present embodiment is an apparatus which controls operation of a vehicle platform in a system which transports a vehicle interior unit which a user is on board by the vehicle platform.

The vehicle platform is, for example, a mobile body including a plurality of wheels and an engine. The vehicle platform only has to have a traveling function and does not necessarily have to include a room. The vehicle platform is configured so as to be able to be coupled to and separated from the vehicle interior unit having a function as a room. The vehicle interior unit can be separated from the vehicle platform at a destination as well as the vehicle platform can move in a state where the vehicle interior unit is loaded.

The vehicle interior unit according to the present embodiment includes seats, seat belts, or the like, and functions as a vehicle interior in a state where the vehicle interior unit is coupled to the vehicle platform.

Further, the vehicle interior unit functions as meeting space in a state where the vehicle interior unit is separated from the vehicle platform.

For example, in a case where a user desires to move to a predetermined destination after meeting with a plurality of people, the vehicle platform transports the vehicle interior unit to a predetermined location while loading the vehicle interior unit, and installs the vehicle interior unit as meeting space.

Further, in a case where all the people who are to meet arrive at the vehicle interior unit, the vehicle platform picks up the vehicle interior unit and transports the vehicle interior unit to the destination.

An information processing apparatus according to the embodiment is an apparatus which controls such a vehicle platform which transports the vehicle interior unit.

Specifically, a controller transmits a first command to transport the vehicle interior unit to a first location and install the vehicle interior unit to one of a plurality of vehicle platforms.

The vehicle platform which has received the first command transports a predetermined vehicle interior unit to a location where people are to meet and installs the vehicle interior unit. By this configuration, it is possible to install space appropriate for meeting at any location.

Note that a first vehicle platform does not have to stay at a location of the user along with the vehicle interior unit. For example, after the vehicle interior unit is separated, another operation may be provided to the first vehicle platform. According to such a configuration, it is possible to improve an operation rate of the vehicle platform.

Further, in a case where all people who are to be on board the vehicle interior unit and move are on board the installed vehicle interior unit, the controller transmits a second command to transport the vehicle interior unit to a second location which is a destination of the people to one of the plurality of vehicle platforms.

By transporting the vehicle interior unit as is to the destination by the vehicle platform in a case where all of the plurality of people who are to meet gather together, it is possible to shorten travel time.

Further, the first command may include a command to travel to the first location and a command to separate the vehicle interior unit from the vehicle platform at the first location.

Further, the second command may include a command to travel to the first location, a command to couple the vehicle interior unit to the vehicle platform at the first location, and a command to travel to the second location. Separation and coupling of the vehicle interior unit can be performed using a publicly known method. Note that the vehicle platform may load the vehicle interior unit or may tow the vehicle interior unit.

Further, the controller may acquire status data indicating a boarding status of the people on the installed vehicle interior unit.

The status data may be, for example, acquired from a computer provided at the vehicle interior unit or may be acquired from a user terminal (such as a smartphone) located within the vehicle interior unit.

Further, the vehicle platform can transport a plurality of vehicle interior units at the same time, and, in a case where there is a second vehicle interior unit which is installed at a third location and which people whose destination is the second location are on board, the controller may transmit a third command to transport the second vehicle interior unit along with the vehicle interior unit, to the vehicle platform which is transporting the vehicle interior unit to the second location.

In this manner, the vehicle platform may pick up a plurality of vehicle interior units whose destinations are the same (or substantially the same) and may transport these plurality of vehicle interior units at the same time. According to such a configuration, it is possible to maximize transportation capability by a single vehicle platform.

Further, the controller may receive an operation request which designates the first location and arrival time of the vehicle interior unit at the first location, from the user terminal.

Further, the controller may select the vehicle platform which transports the vehicle interior unit to the first location on the basis of the operation request.

The controller can generate an operation plan of the vehicle platform on the basis of the received operation request. For example, the controller may select the vehicle platform which can arrive at the designated location by the designated time.

The embodiments of the present disclosure will be described below on the basis of the drawings.

Configurations of the embodiments described below are merely an example, and the present disclosure is not limited to the configurations of the embodiments.

### First Embodiment

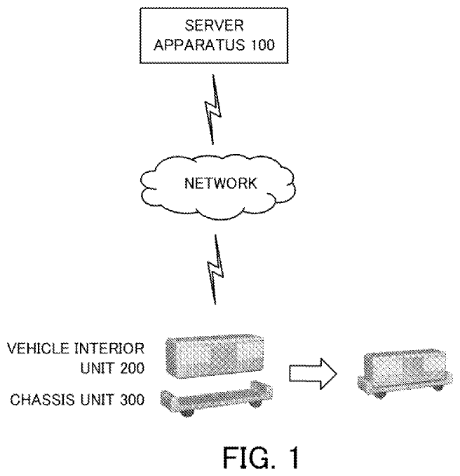

Outline of a vehicle system according to a first embodiment will be described with reference to FIG. 1. The vehicle system according to the present embodiment includes one or more vehicle platforms which autonomously travel on the basis of a provided command, one or more vehicle interior units 200 which are loaded on the respective vehicle platforms, and a server apparatus 100 which issues the command.

Hereinafter, the vehicle platform will be referred to as a chassis unit 300. Further, a term of the vehicle interior unit is used as a term which collectively refers to a plurality of vehicle interior units which also function as meeting space alone.

The chassis unit 300 is an autonomous driving vehicle which can travel while loading the vehicle interior unit 200. The chassis unit 300 operates on the basis of the command received from the server apparatus 100. Note that the chassis unit 300 does not necessarily have to be an unmanned vehicle. For example, an observer, or the like, may be on board the chassis unit 300. Further, the chassis unit 300 does not necessarily have to be a vehicle which can completely autonomously travel. For example, the chassis unit 300 may be a vehicle which a person drives or a vehicle which supports driving depending on situations.

Further, the chassis unit 300 can be coupled to and separated from the vehicle interior unit 200.

The chassis unit 300 and the vehicle interior unit 200 belong to an operation hub. At the operation hub, it is possible to store the chassis unit 300 and the vehicle interior unit 200 which are not operating.

The server apparatus 100 is an apparatus which provides mobile service to the user by controlling the chassis unit 300.

Specifically, the server apparatus 100 manages the chassis unit 300 and the vehicle interior unit 200 and determines combination of the chassis unit 300 and the vehicle interior unit 200 in response to a request from the user.

Then, the server apparatus 100 issues to the chassis unit 300 one of
(1) a command (first command) to transport the vehicle interior unit 200 to a designated location and install the vehicle interior unit as meeting space and
(2) a command (second command) to pick up the vehicle interior unit which passengers are on board and transport the vehicle interior unit to a destination.

Note that, in the present embodiment, “installing the vehicle interior unit” indicates separating the vehicle interior unit 200 transported by the chassis unit 300 from the chassis unit 300 at any location (such as private property and public space), installing the vehicle interior unit and causing the vehicle interior unit to function as meeting space. Further, in the present specification, “picking up the vehicle interior unit” indicates coupling the installed vehicle interior unit 200 to the chassis unit 300 again to make up a vehicle.

The server apparatus 100, the vehicle interior unit 200 and the chassis unit 300 are connected to one another with a network. As the network, for example, a WAN (Wide Area Network) which is a global public telecommunication network such as the Internet and other communication networks may be employed. Further, the network may include a telecommunication network such as a mobile phone and a wireless communication network such as Wi-Fi (registered trademark).

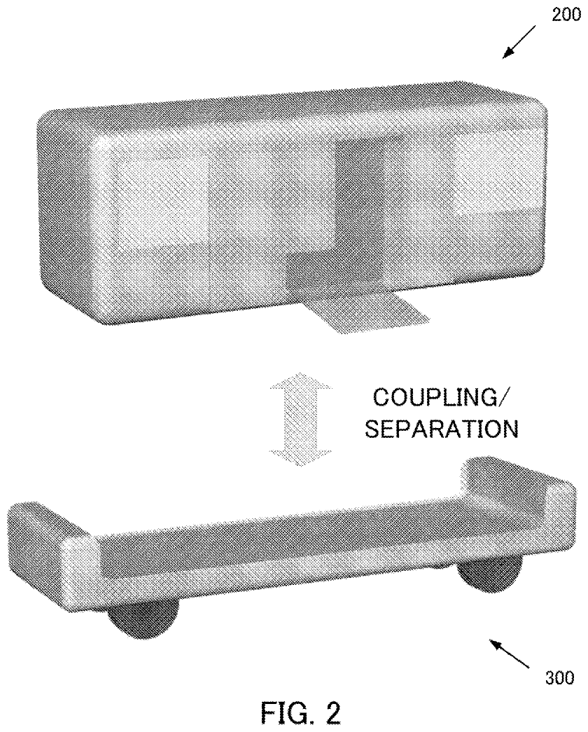

FIG. 2 is a view illustrating appearance of a vehicle. The vehicle according to the present embodiment is constituted with the chassis unit 300 and the vehicle interior unit 200.

The chassis unit 300 is an automobile which autonomously travels through automated driving. The chassis unit 300 includes wheels, an engine or an electric motor, a device which controls traveling, an automated driving device, or the like, and travels in accordance with a predetermined command transmitted from a device which manages operation of the chassis unit 300. The chassis unit 300 can travel alone as well as moving while loading one or more vehicle interior units 200.

Note that, while, in the present embodiment, the chassis unit 300 is an autonomous traveling vehicle, the chassis unit 300 may be a vehicle which a driver drives or a semi-autonomous traveling vehicle which travels under observation by the driver.

The vehicle interior unit 200 is a unit for transporting the user and a unit which has a predetermined facility. While, for example, examples of the predetermined facility can include a seat, a table, lighting, an air-conditioning facility, or the like, if the facility can be provided in the vehicle interior, the predetermined facility may be a facility other than these facilities. Further, the vehicle interior unit 200 functions as meeting space in a state where the vehicle interior unit 200 is separated from the chassis unit. The vehicle interior unit 200 may include a facility (such as a drinking and eating facility, a computer, a TV set and a network facility) which is to be utilized by the user during waiting.

Note that, while, in the above-described example, the vehicle interior unit 200 is loaded on the chassis unit 300, the vehicle interior unit 200 does not necessarily have to be loaded on the chassis unit 300 if the chassis unit 300 can be coupled to the vehicle interior unit 200 using a predetermined method.

A method for coupling the chassis unit 300 and the vehicle interior unit 200 is not limited to a particular method. For example, the vehicle interior unit 200 may be mechanically coupled to and separated from the chassis unit 300 with a locking mechanism, or coupling and separation may be realized by utilizing an electromagnet, or the like.

Further, examples of a method for loading or unloading the vehicle interior unit 200 on and from the chassis unit 300 can include, for example, a method using a dedicated lift, a method using a mechanism provided at the chassis unit 300 or the vehicle interior unit 200 itself, or the like. A method for loading or unloading the vehicle interior unit 200 on and from the chassis unit 300 is not limited to a particular method.

It is assumed in the present embodiment that the chassis unit 300 includes a lift with which to autonomously load and unload a given vehicle interior unit 200.

The server apparatus 100 issues a command (hereinafter, an operation command) to command the chassis unit 300 to operate. The operation command includes a command to move, a command to install/pick up the vehicle interior unit 200 using a lift, or the like.

The server apparatus 100 generates, for example, an operation command to load a predetermined vehicle interior unit 200 at a predetermined operation hub, travel to a predetermined meeting point and, after arriving at the point, unload and install the vehicle interior unit 200, and transmits the operation command to the chassis unit 300.

Further, the server apparatus 100 generates, for example, an operation command to load the installed vehicle interior unit 200 at the meeting point and travel to a designated destination, and transmits the operation command to the chassis unit 300.

Details of the server apparatus 100 will be described next.

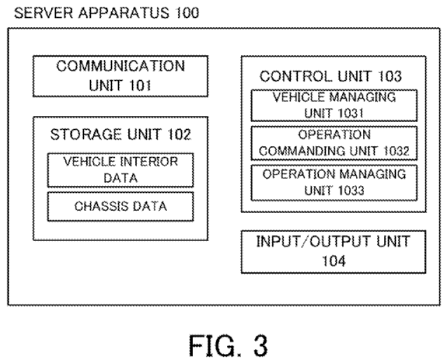

FIG. 3 is a view illustrating a system configuration of the server apparatus 100. The server apparatus 100 includes a communication unit 101, a storage unit 102, a control unit 103 and an input/output unit 104.

The server apparatus 100 is constituted with a typical computer. That is, the server apparatus 100 is a computer having a processor such as a CPU and a GPU, a main memory such as a RAM and a ROM, and an auxiliary memory such as an EPROM, a hard disk drive and a removable medium. Note that the removable medium may be, for example, a USB memory or a disk storage medium such as a CD and a DVD. In the auxiliary memory, an operating system (OS), various kinds of programs, various kinds of tables, or the like, are stored, and by the programs stored therein being loaded to a working area of the main memory and executed, and respective components, or the like, being controlled through execution of the programs, various functions which suit predetermined purpose as will be described later can be realized. However, part or all of the functions may be realized by a hardware circuit such as an ASIC and an FPGA. Note that the server apparatus 100 may be constituted with a single computer or may be constituted with a plurality of computers which coordinate with each other.

The communication unit 101 is a communication interface for connecting the server apparatus 100 to a network. The communication unit 101, for example, includes a network interface board or a wireless communication circuit for wireless communication.

The storage unit 102 includes a main memory and an auxiliary memory. The main memory is a memory to which a program to be executed by the control unit 103 and data to be utilized by the control program are to be deployed. The auxiliary memory is a device in which a program to be executed by the control unit 103 or data to be utilized by the control program is stored.

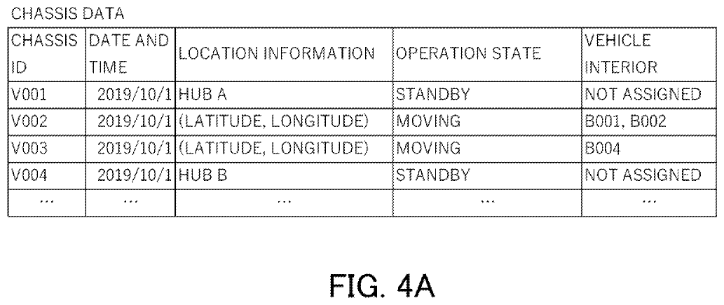

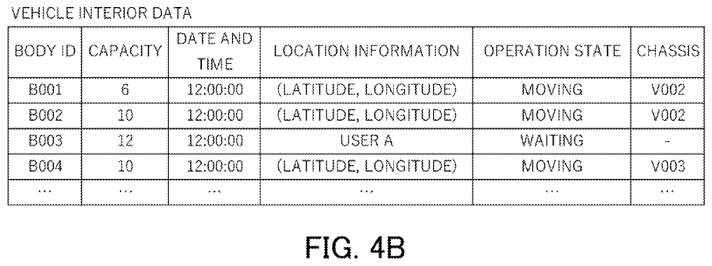

Further, the storage unit 102 stores vehicle interior data and chassis data. FIG. 4A and FIG. 4B are examples of the vehicle interior data and the chassis data which are stored.

The chassis data includes location information, an operation state (such as whether the chassis unit 300 is on standby, transporting the vehicle interior unit 200 or deadheaded) of the chassis unit 300 under control of the server apparatus 100, information for specifying the transporting vehicle interior unit 200, or the like.

Further, the vehicle interior data includes an attribute (such as capacity), location information, an operation state (such as whether the vehicle interior unit 200 is separated, or is loaded on the chassis unit 300 and traveling) of the vehicle interior unit 200 under control, information for specifying the paired chassis unit 300, or the like.

The chassis data and the vehicle interior data can be periodically updated on the basis of information transmitted from the chassis unit 300 and the vehicle interior unit 200. Note that, in a case where the respective units are in a non-operating state, information received last may be dealt with as the latest information.

A database which stores these kinds of data is constructed by managing data stored in the memory by a program of a database management system (DBMS) to be executed by a processor. The database utilized in the present embodiment is, for example, a relational database.

The control unit 103 is an arithmetic device which manages control to be performed by the server apparatus 100. The control unit 103 can be realized with an arithmetic processing unit such as a CPU.

The control unit 103 includes three functional modules of a vehicle managing unit 1031, an operation commanding unit 1032, and an operation managing unit 1033. The respective functional modules may be realized by a program stored in auxiliary storage being executed by the CPU.

The vehicle managing unit 1031 periodically performs communication with a plurality of chassis units 300 and vehicle interior units 200 to collect information regarding the chassis units 300 and the vehicle interior units 200. The collected information is reflected in the vehicle interior data and the chassis data.

The operation commanding unit 1032 generates a command (operation command) to operate the chassis unit 300. The operation commanding unit 1032 commands the chassis unit 300 to, for example, “install the vehicle interior unit 200 at a predetermined point and return”, or “pick up the vehicle interior unit 200 at a predetermined point and head to a designated destination”. The chassis unit 300 autonomously travels in accordance with the operation command generated by the operation commanding unit 1032 and installs or picks up the vehicle interior unit 200.

The operation managing unit 1033 triggers operation of the chassis unit 300 on the basis of a result of communication with a terminal (user terminal) possessed by the user, the vehicle interior unit 200, or the like.

For example, in a case where an operation request of a vehicle is received from the user terminal, the operation managing unit 1033 determines combination of the chassis unit 300 and the vehicle interior unit 200 and triggers the operation. The operation managing unit 1033 generates, via the operation commanding unit 1032, an operation command to load the predetermined vehicle interior unit 200 on the chassis unit 300, transport the vehicle interior unit 200 to a point designated by the user and install the vehicle interior unit 200. The operation to be performed by this will be referred to as first operation.

Further, the operation managing unit 1033 acquires data (status data) regarding meeting to be performed at the vehicle interior unit 200, and, in a case where the status data satisfies predetermined conditions (for example, in a case where all people who are to meet are on board the vehicle interior unit 200), the operation managing unit 1033 triggers the operation of the chassis unit 300. The operation managing unit 1033 generates, via the operation commanding unit 1032, an operation command to pick up the vehicle interior unit 200 installed as meeting space and transport the vehicle interior unit 200 to a destination designated by the user. The operation to be performed by this will be referred to as second operation.

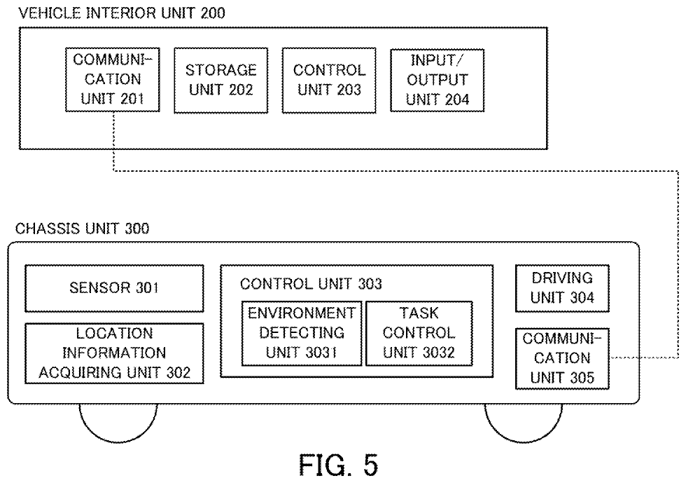

The vehicle interior unit 200 and the chassis unit 300 will be described next with reference to FIG. 5.

The vehicle interior unit 200 includes a communication unit 201, a storage unit 202, a control unit 203 and an input/output unit 204. The vehicle interior unit 200 operates with power supplied from a battery.

The communication unit 201 is a communication interface for performing communication with the server apparatus 100 and the chassis unit 300.

The storage unit 202 is a unit configured to store information and is configured with a RAM or a storage medium such as a magnetic disk and a flash memory.

The control unit 203 is a computer which controls operation of the vehicle interior unit. The control unit 203 is configured with, for example, a microcomputer. The control unit 203 may be realized by a program stored in storage such as a read only memory (ROM) being executed by a central processing unit (CPU).

In the present embodiment, the control unit 203 is configured so as to be able to acquire information regarding a status of meeting to be performed within the vehicle interior unit 200. For example, the control unit 203 can acquire information regarding the number of people who are to meet, the number of people who have arrived at the vehicle interior unit 200, scheduled time for meeting, a final destination, or the like. Further, in a case where all the people who are to meet arrive and are on board the vehicle interior unit 200, the control unit 203 requests the server apparatus 100 to pick up the vehicle interior unit 200. A specific method will be described later.

The input/output unit 204 is an interface for inputting/outputting information. The input/output unit 204 is configured with, for example, a display device and a touch panel. The input/output unit 204 may include a keyboard, a camera, near field communication unit, a touch screen, or the like.

The chassis unit 300 will be described next.

The chassis unit 300 is a vehicle platform which travels in accordance with the operation command acquired from the server apparatus 100. Specifically, the chassis unit 300 generates a traveling route on the basis of the operation command acquired through wireless communication and travels on a road using an appropriate method while sensing the circumference of the vehicle. Further, the chassis unit 300 can load and unload the vehicle interior unit 200. By this configuration, it is possible to install and pick up the vehicle interior unit 200 in an unmanned state.

The chassis unit 300 includes a sensor 301, a location information acquiring unit 302, a control unit 303, a driving unit 304 and a communication unit 305. The chassis unit 300 operates with power supplied from a battery.

The sensor 301 is a device configured to sense the circumference of the vehicle, and typically includes a stereo camera, a laser scanner, an LIDAR, a radar, or the like. Information acquired by the sensor 301 is transmitted to the control unit 303. The sensor 301 includes a sensor for autonomous travel.

The sensor 301 may include a camera provided at the chassis unit 300. For example, the sensor 301 can include an imaging device using an image sensor such as Charged-Coupled Devices (CCD), a Metal-oxide-semiconductor (MOS) and a Complementary Metal-Oxide-Semiconductor (CMOS).

The location information acquiring unit 302 is a unit configured to acquire a current location of the chassis unit 300 and typically includes a GPS receiver, or the like. Information acquired by the location information acquiring unit 302 is transmitted to the control unit 303.

The control unit 303 is a computer which controls the chassis unit 300 on the basis of the information acquired from the sensor 301. The control unit 303 is configured with, for example, a microcomputer.

The control unit 303 includes an environment detecting unit 3031 and a task control unit 3032 as functional modules. The respective functional modules may be realized by a program stored in storage such as a read only memory (ROM) being executed by a central processing unit (CPU).

The environment detecting unit 3031 detects an environment around the vehicle on the basis of data acquired by the sensor 301. While a detection target is, for example, the number and positions of lanes, the number and positions of vehicles existing around the own vehicle, the number and positions of obstacles (such as pedestrians, bicycles, structures and buildings) existing around the own vehicle, a structure of the road, a road sign, or the like, the detection target is not limited to these. The detection target may be any object if the object is necessary for autonomous travel. Further, the environment detecting unit 3031 may track the detected object.

Data regarding the environment detected by the environment detecting unit 3031 (hereinafter, environment data) is transmitted to the task control unit 3032 which will be described later.

The task control unit 3032 controls travel of the own vehicle on the basis of the operation command received from the server apparatus 100, the environment data generated by the environment detecting unit 3031 and location information of the own vehicle acquired by the location information acquiring unit 302. For example, the task control unit 3032 causes the own vehicle to travel so as to travel along a predetermined route and so that an obstacle does not enter a predetermined safety area centering around the own vehicle. As a method for causing a vehicle to autonomously travel, a publicly known method can be employed.

The traveling route may be, for example, automatically generated on the basis of a provided departure place and destination with reference to map data stored in advance. Further, the traveling route may be generated by utilizing external service.

Further, the task control unit 3032 executes a predetermined task on the route or at the destination on the basis of the operation command. While the task includes, for example, “separate the vehicle interior unit 200 and install the vehicle interior unit 200 at a designated point”, “pick up the vehicle interior unit 200” or “notify the user of arrival of the vehicle”, the task is not limited to these.

The driving unit 304 is a unit configured to cause the chassis unit 300 to travel on the basis of the command generated by the task control unit 3032. The driving unit 304 includes, for example, a motor and an inverter for driving wheels, a brake, a steering mechanism, a secondary battery, or the like.

The communication unit 305 is a communication unit configured to connect the chassis unit 300 to a network. In the present embodiment, it is possible to perform communication with the server apparatus 100 and the vehicle interior unit 200 via a network by utilizing mobile communication service such as 3G, LTE and 5G.

Note that the communication unit 305 may further include a communication unit for performing inter-vehicle communication with other vehicles.

The chassis unit 300 can load the vehicle interior unit 200 in the vehicle interior or on a cargo bed. The chassis unit 300 may be configured so as to be able to load a plurality of vehicle interior units 200. The chassis unit 300 includes a mechanism (such as an elevator, an actuator and a guide rail) for loading and unloading only a predetermined vehicle interior unit 200 among the plurality of vehicle interior units 200. These components are controlled by the task control unit 3032.

The vehicle interior unit 200 and the chassis unit 300 periodically notify the server apparatus 100 of own statuses during operation. The server apparatus 100 (vehicle managing unit 1031) updates the chassis data and the vehicle interior data with the notified information. An example of the information (status information) to be transmitted will be described below.

<Chassis Unit 300>
location information
size, weight, the number, or the like, of vehicle interior units which can be coupled
identifier of a vehicle interior unit which is currently coupled
current remaining battery level (SOC)
travelable distance
information regarding a traveling route (in a case where the chassis unit 300 is traveling)
information regarding installation/pickup of the vehicle interior unit

<Vehicle Interior Unit 200>
location information
chassis unit which can be coupled
identifier of a chassis unit which is currently coupled
current remaining battery level (SOC)
information regarding meeting

A method for the chassis unit 300 to transport the vehicle interior unit 200 will be described next.

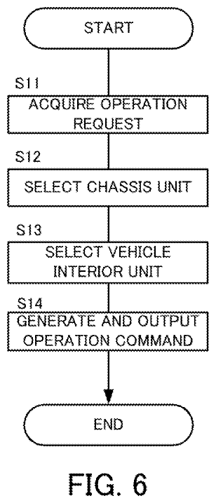

FIG. 6 is a flowchart of processing of the server apparatus 100 generating an operation command on the basis of an operation request acquired from the user.

In step S11, the operation managing unit 1033 acquires an operation request from a terminal (user terminal) possessed by the user. The operation request includes the following information.
desired location of installation of the vehicle interior unit which becomes meeting space
desired time of installation of the vehicle interior unit
scheduled time of departure
the number of people who are to meet
destination headed to after meeting

In step S12, the operation managing unit 1033 selects the chassis unit 300 which transports the vehicle interior unit 200. For example, the operation commanding unit 1032 determines the chassis unit 300 which can provide service with reference to the stored location information and the operation state of the chassis unit 300.

In the present step, for example, a chassis unit which can arrive at a designated location by designated time is selected.

Then, in step S13, the operation managing unit 1033 determines the vehicle interior unit 200 to be loaded on the chassis unit 300. In the present step, an operation hub which can provide the vehicle interior unit 200 which meets the request of the user is specified with reference to the vehicle interior data.

In the present step, a vehicle interior unit which suits designated conditions (for example, a vehicle interior unit which the requested number of people can be on board) may be selected.

In a case where there are a plurality of operation hubs which can provide the vehicle interior unit 200, a hub which is the closest from a designated point may be selected, or a hub which is the closest from the chassis unit 300 selected in step S12 may be selected. Further, in a case where there are a plurality of vehicle interior units 200 which meet the request of the user, the vehicle interior units 200 may be narrowed down by an attribute of the user. For example, in a case where a plurality of vehicle interior units 200 having different specifications exist as candidates, the vehicle interior unit 200 which is over-engineered for the user may be excluded from the candidates. Note that, in a case where an appropriate vehicle interior unit 200 has already been loaded on the chassis unit 300 selected in step S12, step S13 may be omitted.

In step S14, the operation commanding unit 1032 generates an operation command (first command) which specifies a task to be performed by the chassis unit 300 and transmits the operation command to the chassis unit 300.

The operation command generated here is a command to (1) load the vehicle interior unit 200 determined by the operation managing unit 1033, (2) travel to a location designated by the user, and (3) separate the vehicle interior unit 200 after arrival and install the vehicle interior unit 200.

In a case where operation of the chassis unit 300 is started, the user terminal is notified of the start of operation. At this time, the user terminal may be notified of information for visually identifying the vehicle interior unit 200, scheduled arrival time, or the like.

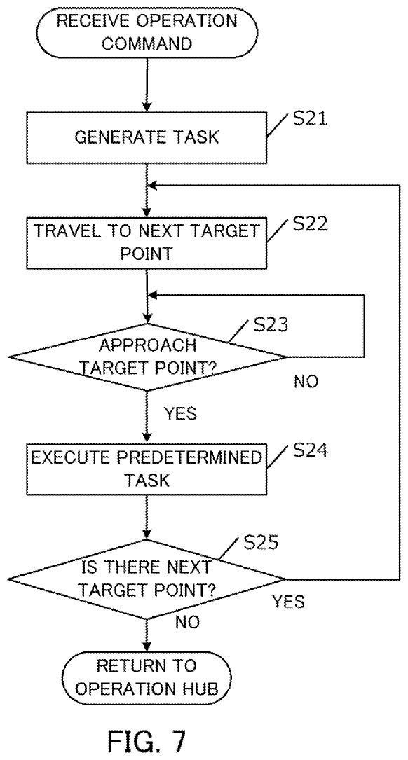

FIG. 7 is a flowchart of processing to be performed by the chassis unit 300 which has received the operation command.

Here, description will be provided using an example of a case where the vehicle interior unit 200 is transported to a meeting place.

In step S21, the chassis unit 300 (task control unit 3032) generates a task on the basis of the received operation command. For example, the chassis unit 300 generates a task to load the vehicle interior unit at a predetermined operation hub, a task to move to a designated point, a task to install the vehicle interior unit 200 at the point and a task to return to the operation hub.

In step S22, the task control unit 3032 starts traveling to a target point on the basis of the generated task. Note that status information is periodically transmitted to the server apparatus 100 also during operation.

If the chassis unit 300 approaches the target point (step S23), the task control unit 3032 searches for a location at which the chassis unit 300 can stop in the vicinity, stops, and executes a predetermined task (step S24). While the predetermined task is, for example, loading, installing and picking up the vehicle interior unit 200, calling the user, or the like, the predetermined task may be other operation.

Then, the task control unit 3032 determines whether or not there is a next target point on the basis of the generated task (step S25), and, in a case where there is a next target point, the chassis unit 300 continues operation. In a case where there is no next target point, the chassis unit 300 returns to the operation hub.

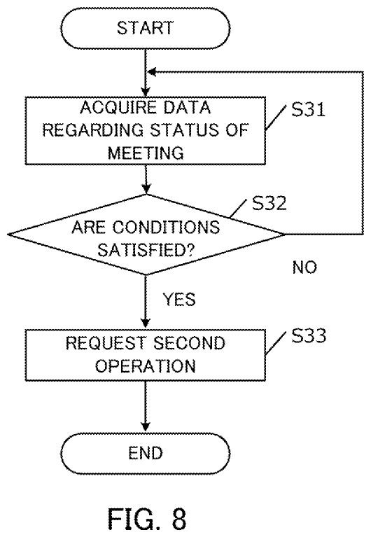

If the vehicle interior unit 200 is installed at a predetermined point, utilization of the vehicle interior unit as meeting space is started. FIG. 8 is a flowchart of processing to be performed by the vehicle interior unit 200 (control unit 203) after meeting space is installed.

First, in step S31, data regarding a status of meeting (status data) is acquired. The status data includes, for example, the number of people who are on board the vehicle interior unit 200. The status data may be transmitted from the vehicle interior unit 200 along with the status information.

The status data may be acquired via the input/output unit 204 or may be generated by the control unit 203 on the basis of a result of sensing the user. For example, an image within the vehicle interior may be acquired, and the number of people within the vehicle interior may be counted on the basis of the image. Further, it is also possible to determine that all the people get together by performing communication with terminals (such as mobile phones) possessed by the respective users.

Then, in step S32, it is determined whether or not the status data satisfies predetermined conditions. For example, in a case where the number of people who are on board the vehicle interior unit reaches the number of people designated in the operation request, it is determined that the conditions are satisfied. In a case where a positive result is obtained in the determination in the present step, the processing proceeds to step S33. In a case where a negative result is obtained in the determination, the processing returns to step S31.

In step S33, a request for second operation by the chassis unit 300 is made to the server apparatus 100 (operation managing unit 1033).

The operation managing unit 1033 which has received the request determines the chassis unit 300 to be dispatched to pick up the vehicle interior unit 200 with reference to the chassis data. Further, an operation command (second operation) to pick up the vehicle interior unit 200 and transport the vehicle interior unit 200 to a designated destination is generated via the operation commanding unit 1032 and transmitted to the determined chassis unit 300.

Note that it is also possible to make a confirmation to the user in advance before operation is requested.

Further, while, in the present example, the vehicle interior unit 200 acquires the status data and, in a case where the conditions are satisfied, a request for the second operation is made to the server apparatus 100, the server apparatus 100 may periodically acquire the status data from the vehicle interior unit 200, and the server apparatus 100 may judge whether or not the conditions are satisfied.

The chassis unit 300 which has received the operation command (second command) executes a task to pick up the designated vehicle interior unit 200 through processing illustrated in FIG. 7.

Specifically, the chassis unit 300 executes a task of traveling while setting a meeting place as a target point and loading the vehicle interior unit 200. Further, after loading of the vehicle interior unit 200 is completed, the chassis unit 300 executes a task of traveling while setting a destination designated by the user as the target point.

As described above, according to the first embodiment, it is possible to transport the user using the vehicle interior unit which functions as meeting space. Particularly, because the chassis unit 300 can perform different tasks from when meeting space is installed until when all the people get together, it is possible to improve an operation rate of the vehicle platform.

### Second Embodiment

While, in the first embodiment, one chassis unit 300 loads only one vehicle interior unit 200, the chassis unit 300 may be configured so as to be able to load a plurality of vehicle interior units 200.

In this case, one chassis unit may load and transport a plurality of vehicle interior units 200 whose destinations are the same or close.

For example, when the server apparatus 100 selects a chassis unit in step S12, the server apparatus 100 determines whether or not there is a chassis unit which satisfies the following conditions.
the chassis unit is currently performing second operation
a final destination of the second operation is the same as or close to a destination of a vehicle interior unit which is to be newly transported
the chassis unit can pick up a new vehicle interior unit without largely deviating from the previous route

In a case where there exists a chassis unit 300 which satisfies these conditions, the server apparatus 100 transmits an operation command (third command) to load the second and subsequent vehicle interior units in addition to the scheduled vehicle interior unit and transport the vehicle interior units to a destination together, to the corresponding chassis unit 300.

The chassis unit 300 adds a task of picking up the second and subsequent vehicle interior units in accordance with the third command.

According to such a configuration, because it is possible to transport a plurality of vehicle interior units 200 with one chassis unit 300, it is possible to improve transportation efficiency.

### Third Embodiment

While, in the first and the second embodiments, the server apparatus 100 issues a command of operation to the chassis unit 300, part or all of judgment to be performed by the server apparatus 100 may be performed by the chassis unit 300.

For example, in step S11, the user may directly request operation to any chassis unit 300. In this case, execution of step S12 is omitted. Further, in this case, the server apparatus 100 may perform only management of the chassis data and may provide data (such as a current location) to the chassis unit 300 as necessary.

Further, in step S33, the vehicle interior unit 200 may directly request pickup to a given chassis unit 300, and the chassis unit 300 may pick up the vehicle interior unit 200 in response to this.

### MODIFIED EXAMPLES

The above-described embodiments are merely an example, and the present disclosure can be modified and implemented within a range not deviating from the gist of the present disclosure.

For example, the processing and the units described in the present disclosure can be implemented while the processing and the units are freely combined unless technical inconsistency arises.

Further, while, in the description of the embodiments, a term of meeting has been used, there may be one user who is to move using one vehicle interior unit. In this case, the chassis unit 300 may start the second operation immediately after the user is on board the vehicle interior unit.

Further, while, in the description of the embodiments, the second operation is started after all people are on board the vehicle interior unit 200, the second operation may be started in advance. For example, the second operation may be started in a state where a certain number of people gather together so that the chassis unit 300 can depart at scheduled time of departure sharp designated by the operation request.

Further, the chassis unit 300 which performs the first operation may be different from or may be the same as the chassis unit 300 which performs the second operation. Still further, when meeting space is installed, the vehicle interior unit does not necessarily have to be separated from the chassis unit.

Further, while, in the description of the embodiments, the second operation is triggered on the basis of the status data, the second operation may be triggered on the basis of a request from the user or other statuses. For example, the second operation may be started in a case where brightness of outdoors or a traffic amount becomes equal to or less than a predetermined value. According to such a configuration, for example, it is possible to secure security of the vehicle interior unit during the night, or the like.

Further, it is also possible to allow the operation request transmitted from the user terminal to the server apparatus 100 to be corrected later. For example, it is also possible to allow scheduled time of departure, or the like, to be corrected in view of a case where schedule of people who are to meet is changed. Still further, it is also possible to allow a command to go through any point to be issued during the second operation. The command may be issued to the server apparatus 100 or may be directly issued to the chassis unit 300. By this configuration, for example, it is possible to take a measure of “allowing a person who cannot come by scheduled time to get on the vehicle interior unit in the middle of the route”.

Further, while, in the description of the embodiments, the chassis unit 300 has been described, the vehicle system according to the embodiments may be applied to conveyance other than a vehicle. For example, it is also possible to load a vehicle interior unit on an aircraft platform (such as a drone) or a ship platform and transport the vehicle interior unit.

In addition, the processing(s) explained as carried out by a single device may be carried out by a plurality of devices. Alternatively, the processing(s) explained as carried out by different devices may be carried out by a single device. In a computer system, whether each function is achieved by what kind of hardware configuration (server configuration) can be changed in a flexible manner.

The present disclosure can also be achieved by supplying a computer program to a computer that implements the functions explained in the above-mentioned embodiments and modifications, and by reading out and executing the program by one or more processors of the computer. Such a computer program may be supplied to the computer by a non-transitory computer readable storage medium that can be connected with a system bus of the computer, or may be supplied to the computer through a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, any type of medium suitable for storing electronic commands.

What is claimed is:

1. An information processing apparatus which controls a plurality of vehicle platforms which can be coupled to and separated from a predetermined vehicle interior unit, the information processing apparatus comprising:
a controller configured to execute:
transmitting a first command to transport the vehicle interior unit to a first location and install the vehicle interior unit, to one of the plurality of vehicle platforms; and
in a case where all people who are to be on board the vehicle interior unit and move are on board the installed vehicle interior unit, transmitting a second command to transport the vehicle interior unit to a second location which is a destination of the people, to one of the plurality of vehicle platforms.

2. The information processing apparatus according to claim 1,
wherein the first command includes a command to travel to the first location and a command to separate the vehicle interior unit from the vehicle platform at the first location.

3. The information processing apparatus according to claim 1,
wherein the second command includes a command to travel to the first location, a command to couple the vehicle interior unit to the vehicle platform at the first location, and a command to travel to the second location.

4. The information processing apparatus according to claim 1,
wherein the controller acquires status data indicating a boarding status of the people on the installed vehicle interior unit.

5. The information processing apparatus according to claim 4,
wherein the status data is transmitted from the vehicle interior unit.

6. The information processing apparatus according to claim 4,
wherein the status data is transmitted from a user terminal within the vehicle interior unit.

7. The information processing apparatus according to claim 1,
wherein the vehicle platform can transport a plurality of vehicle interior units at a same time, and
in a case where there is a second vehicle interior unit which is installed at a third location and which a person whose destination is the second location is on board,
the controller transmits a third command to transport the second vehicle interior unit along with the vehicle interior unit, to the vehicle platform which is transporting the vehicle interior unit to the second location.

8. The information processing apparatus according to claim 1,
wherein the controller receives an operation request which designates the first location and arrival time of the vehicle interior unit at the first location from a user terminal.

9. The information processing apparatus according to claim 8,
wherein the controller selects the vehicle platform which transports the vehicle interior unit to the first location on a basis of the operation request.

10. An information processing method for controlling a plurality of vehicle platforms which can be coupled to and separated from a predetermined vehicle interior unit, the information processing method comprising:
a step of transmitting a first command to transport the vehicle interior unit to a first location and install the vehicle interior unit, to one of the plurality of vehicle platforms; and
a step of, in a case where all people who are to be on board the vehicle interior unit and move are on board the installed vehicle interior unit, transmitting a second command to transport the vehicle interior unit to a second location which is a destination of the people, to one of the plurality of vehicle platforms.

11. The information processing method according to claim 10, further comprising:
a step of acquiring status data indicating a boarding status of the people on the installed vehicle interior unit.

12. The information processing method according to claim 10,
wherein the vehicle platform can transport a plurality of vehicle interior units at a same time, and
in a case where there is a second vehicle interior unit which is installed at a third location and which a person whose destination is the second location is on board,
a third command to transport the second vehicle interior unit along with the vehicle interior unit is transmitted to the vehicle platform which is transporting the vehicle interior unit to the second location.

13. The information processing method according to claim 10, further comprising:
a step of receiving an operation request which designates the first location and arrival time of the vehicle interior unit at the first location, from a user terminal.

14. The information processing method according to claim 13,
wherein the vehicle platform which transports the vehicle interior unit to the first location is selected on a basis of the operation request.

15. A non-transitory computer readable storing medium recording a computer program for causing a computer to perform the information processing method according to claim 10.

16. A vehicle comprising:
a controller configured to execute:
performing first operation of transporting a predetermined vehicle interior unit to a first location and installing the vehicle interior unit; and
in a case where all people who are to be on board the vehicle interior unit and move are on board the installed vehicle interior unit, performing second operation of transporting the vehicle interior unit to a second location which is a destination of the people.

17. The vehicle according to claim 16,
wherein the controller acquires status data indicating a boarding status of the people on the installed vehicle interior unit.

18. The vehicle according to claim 17,
wherein the status data is transmitted from the vehicle interior unit.

19. The vehicle according to claim 17,
wherein the status data is transmitted from a user terminal within the vehicle interior unit.

20. The vehicle according to claim 16,
wherein the controller receives an operation request which designates the first location and arrival time of the vehicle interior unit at the first location, from a user terminal.
